(19) United States
(12) Patent Application Publication
(10) Pub. No.: US 2009/0210259 A1
(43) Pub. Date: Aug. 20, 2009

(54) INTERNET PROTOCOL DATA INSURANCE POLICY MANAGEMENT SYSTEM

(75) Inventors: Stephen C. Cardot, St. Paul, MN (US); Daryl R. Wilson, Burnsville, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: CLOUD COVER, LTD., St. Paul, MN (US)

(21) Appl. No.: 12/388,292

(22) Filed: Feb. 18, 2009

Related U.S. Application Data
(60) Provisional application No. 61/029,485, filed on Feb. 18, 2008.
(60) Provisional application No. 61/029,500, filed on Feb. 18, 2008.
(60) Provisional application No. 61/029,504, filed on Feb. 18, 2008.
(60) Provisional application No. 61/033,986, filed on Mar. 5, 2008.
(60) Provisional application No. 61/033,993, filed on Mar. 5, 2008.

(51) Int. Cl. G06Q 40/00

(52) U.S. Cl. 705/4

(57) ABSTRACT

An internet protocol data insurance policy management system including creating an insurance policy portfolio. A risk associated with an electronic transmission is determined based upon the insurance policy portfolio. An insurance policy is generated based upon the insurance policy portfolio upon receipt of a electronic transmission identifier from a first computer client. The receipt of the electronic transmission identifier from the first computer is indicative of an electronic transmission being transmitted from the first computer client to a second computer client that is distinct from the first computer client. The insurance policy is terminated when the electronic transmission identifier is received from the second computer client. The receipt of the electronic transmission identifier from the second computer client is indicative of the electronic transmission being received by the second computer client.

### REFERENCE TO RELATED APPLICATION

This application claims priority to U.S. Provisional Applications Nos. 61/029,485, filed Feb. 18, 2008; 61/029,500, filed Feb. 18, 2008; 61/029,504, filed Feb. 18, 2008, 61/033,986 Mar. 5, 2008, and 61/033,993, filed Mar. 5, 2008, the contents of which are incorporated herein by reference.

### FIELD OF THE INVENTION

The invention relates generally to an insurance system. More particularly, the invention relates to an internet protocol data insurance policy management system.

### BACKGROUND OF THE INVENTION

Stephen Cardot, one of the inventors identified in the current patent application, is also identified as an inventor in U.S. Pat. Nos. 6,922,720; 7,020,692; 7,246,157; and 7,349,954, that are each directed to the concept of insuring electronic transmission. The contents of these patents are incorporated herein by reference.

U.S. Pat. No. 6,922,720 includes independent claims that are directed to a system for providing transmission-coverage for transmission of data from a first remote client to a second remote client over a communications network. The system includes a computer server that is communicatively coupled to the first remote client and to the second remote client over the communications network.

The server includes a receiver, a charging mechanism and a logging mechanism. The receiver receives a request from the first remote client to cover transmission of a set of data between the first remote client and the second remote client. The request includes data specifying a selected transmission-coverage type and a selected transmission-coverage amount for the transmission

The charging mechanism operates, based on the request, to charge a transmission-coverage fee to an identified account for the selected transmission-coverage type having the selected transmission-coverage amount. The logging mechanism logs a status of the transmission into a logging data structure. The selected transmission-coverage type is bonding that provides a bonding coverage amount that is payable in the event the transmission fails.

U.S. Pat. No. 7,020,692 includes independent claims that are directed to a system for providing transmission-coverage for transmission of data from a first remote client to a second remote client over a communications network. The system includes a computer server communicatively coupled to the first remote client and to the second remote client over the communications network.

The server includes a receiver, a charging mechanism and a logging mechanism. The receiver receives a request to insure transmission of a set of data between the first client and the second client. The request includes data specifying a coverage amount for the insurance on the transmission.

The charging mechanism operates, based on the request, to charge an insurance premium fee to an identified account. The logging mechanism logs a status of the transmission into a logging data structure. The insurance provides that the coverage amount is payable in the event the transmission fails.

U.S. Pat. No. 7,246,157 includes independent claims that are directed to a method that includes providing selected transmission coverage for one or more transmissions of data that includes a first individual transmission across a network. In the event of failure of a transmission of data across the network, the coverage becomes payable as a selected coverage amount.

The method also includes logging data pertaining to the coverage for the one or more transmissions into a database structure. The method further includes allocating sufficient funds to back the selected coverage amount based, at least in part, upon information tracked in the database structure.

U.S. Pat. No. 7,349,954 includes independent claims that are directed to a computerized method executed in a server contains a processor and a memory. The method includes providing selected transmission coverage for one or more transmissions over a communications network. In the event of a failure of a transmission of data across the network, the coverage becomes payable as a selected coverage amount.

A completion status of the one or more transmissions is verified. This step includes determining whether each of the one or more transmissions was successfully transmitted and received. Data pertaining to the completion status is logged into a logging data structure in a database in the server.

A plurality of failed-transmission-coverage claims are received and authenticated based, at least in part, upon the data contained in the logging data structure. Thereafter, a claim report is generated based upon information tracked in the database.

### SUMMARY OF THE INVENTION

An embodiment of the invention is directed to an internet protocol data insurance policy management system. An insurance policy portfolio is created. A risk associated with an electronic transmission is determined based upon the insurance policy portfolio. An insurance policy is generated based upon the insurance policy portfolio upon receipt of a electronic transmission identifier from a first computer client. The receipt of the electronic transmission identifier from the first computer is indicative of an electronic transmission being transmitted from the first computer client to a second computer client that is distinct from the first computer client.

The insurance policy is terminated when the electronic transmission identifier is received from the second computer client. The receipt of the electronic transmission identifier from the second computer client is indicative of the electronic transmission being received by the second computer client.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a flow diagram of an overview of a data transmission insurance policy management system.

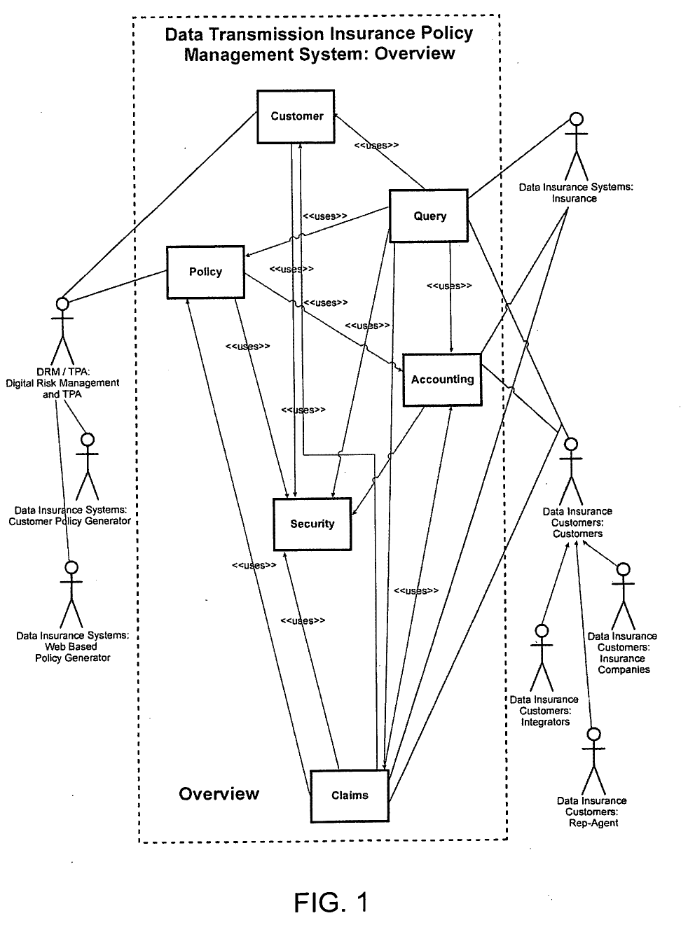

FIG. 2 is a flow diagram of a security module of the data transmission insurance policy management system.

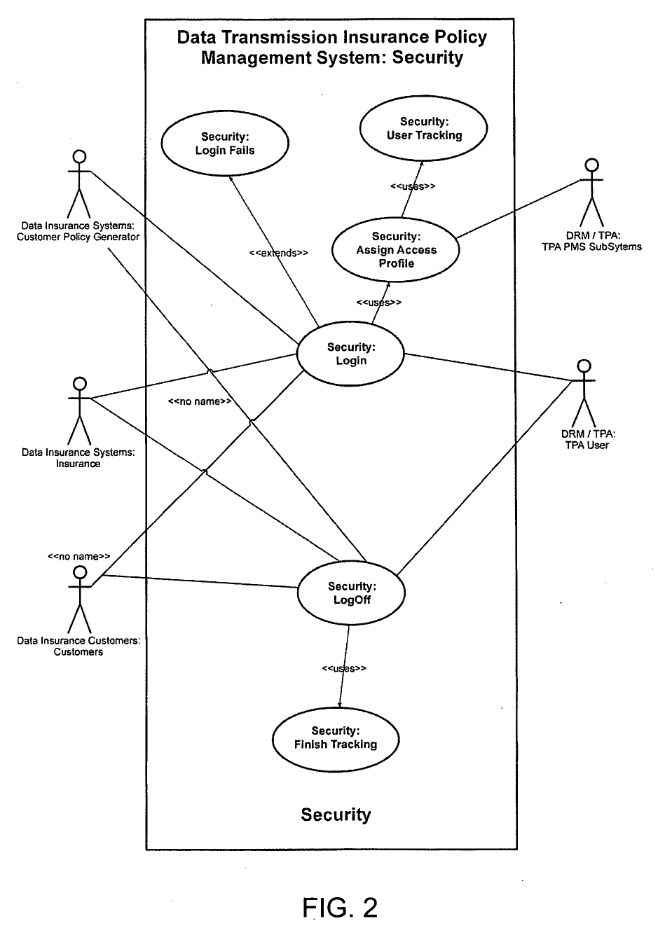

FIG. 3 is a flow diagram of a customer module of the data transmission insurance policy management system.

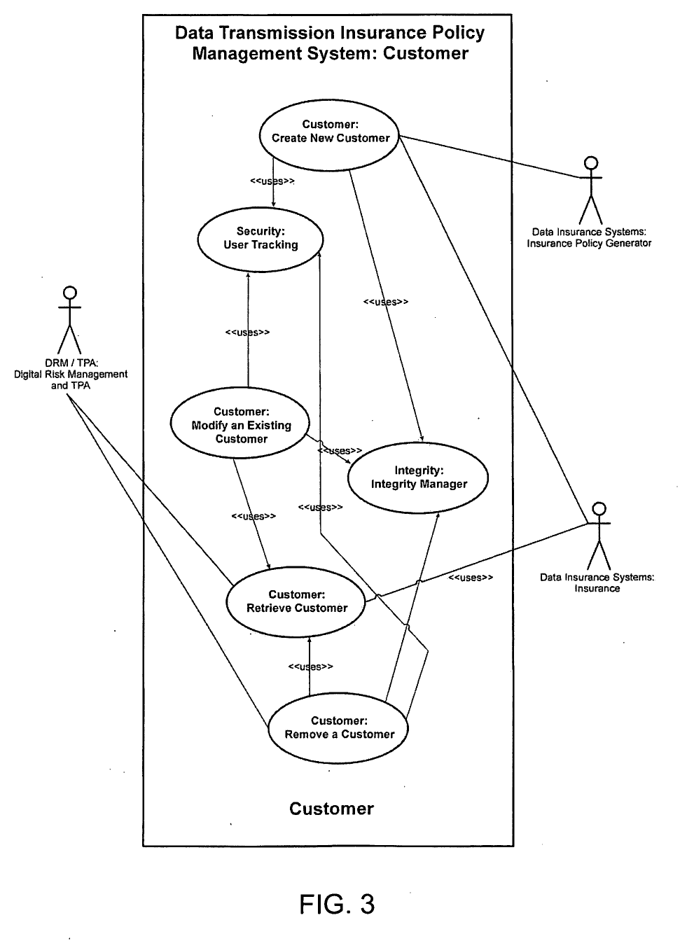

FIG. 4 is a flow diagram of a policy module of the data transmission insurance policy management system.

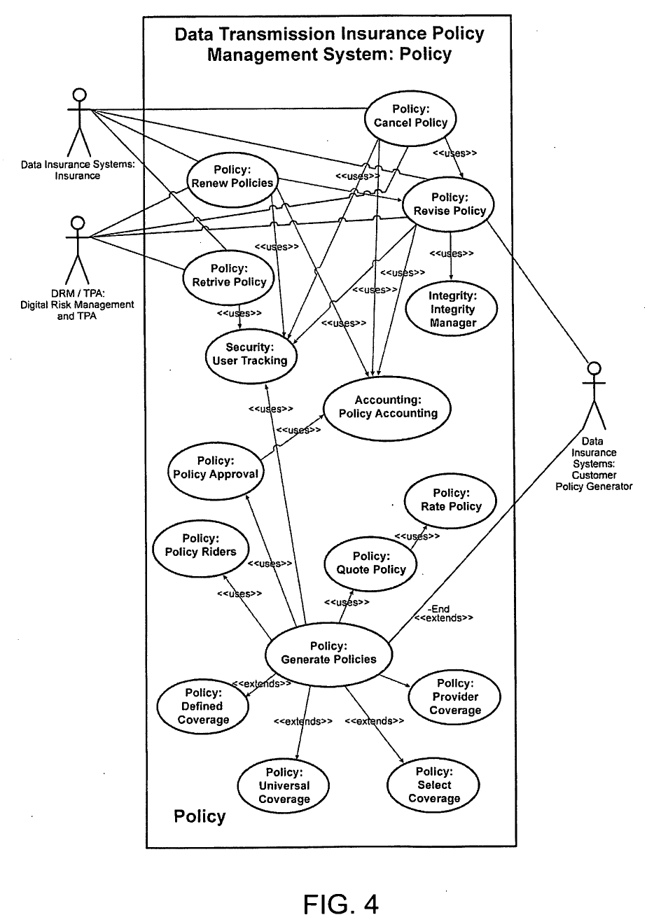

FIG. 5 is a flow diagram of a claims module of the data transmission insurance policy management system.

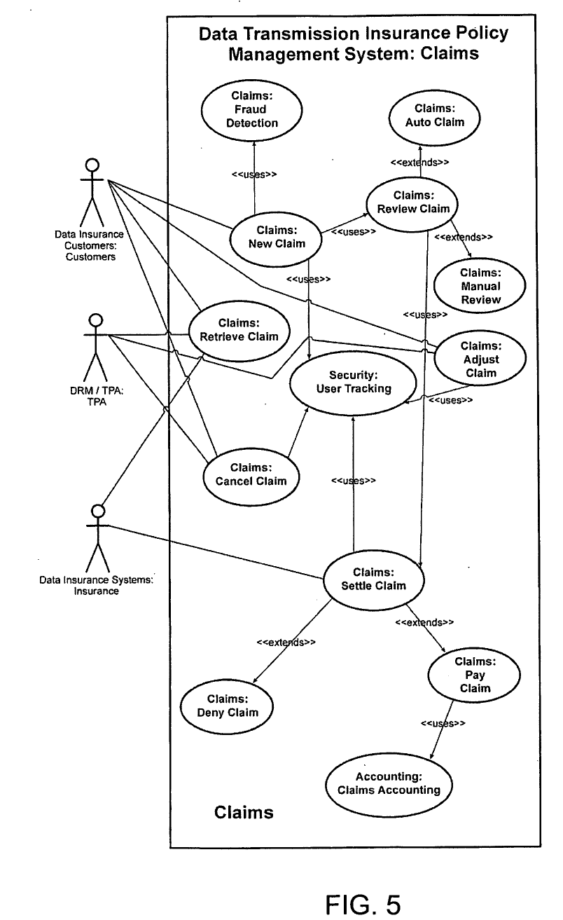

FIG. 6 is a flow diagram of an accounting module of the data transmission insurance policy management system.

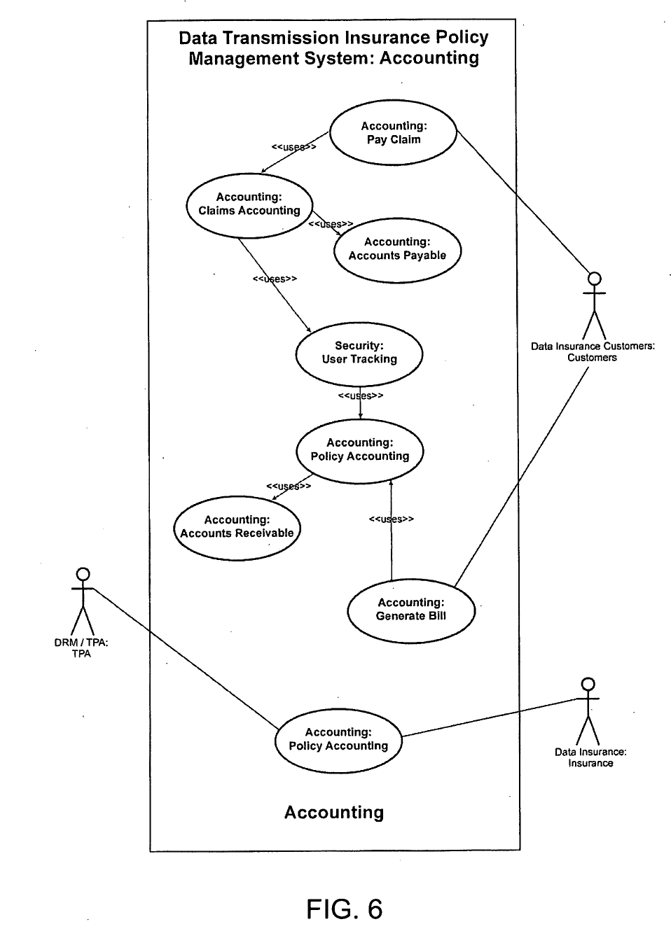

FIG. 7 is a flow diagram of a query module of the data transmission insurance policy management system.

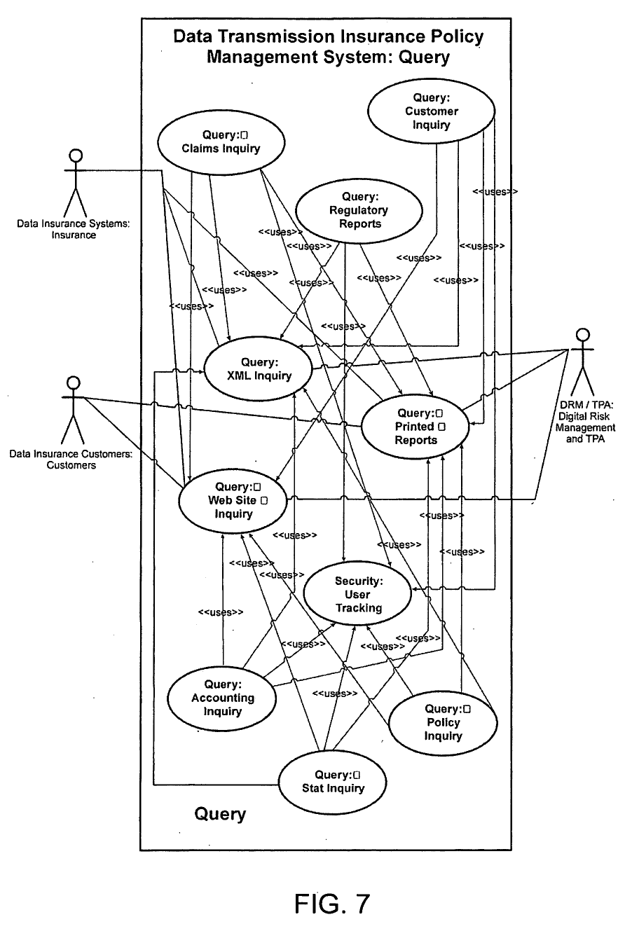

FIG. 8 is a flow diagram of the internet protocol data insurance policy management system.

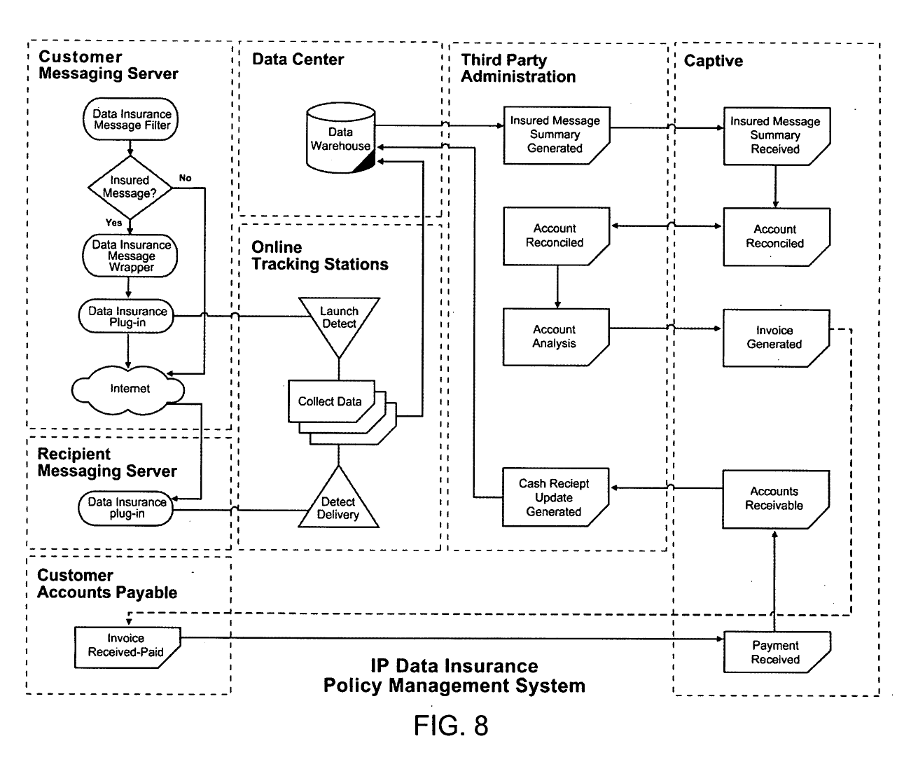

### DETAILED DESCRIPTION OF THE PREFERRED EMBODIMENTS

The internet protocol data insurance policy management system is illustrated in the accompanying figures and described herein.

At the time a sales agreement is constructed, a policy and it premiums are automatically calculated-generated and stored in the Policy Management System. This system will have to encompass all the business knowledge needed to underwrite, rate and calculate premiums and generate policy contract. It starts with the risk assessment audit, when policy requirements are defined and agreed upon (using the Policy Generator of the Policy Management System) and continues through the complete policy life cycle.

Policy information will have to be available for other processes to use for authentication and validation of activities. The system will retain (on line) all information pertinent to current policies and information regarding any historical policy information that may still be viable for claims (i.e. requires “generational” views of the policies).

Within the Internet Protocol Data PMS policy lifecycle is also the need for audits and reviews. Policy can be written to include an audit clause. This type of clause allows Internet Protocol Data Insurance to audit the customer's activities in relation to the assumptions made at the time the policy was created and to verify that all policy compliance and insuring conditions are being met. The audit may result in a premium increase or a refund to the customer. This occurs at the policy renewal time. The notification of these audits and reviews will be performed by the system. Rates reviews are adjustable for individual transactions based on its individual characteristics.

Insurance is a highly regulated industry and as such has many regulatory authorities under which it will function and to which it will report. Internet Protocol Data Insurance will understand and work and comply with these rules. A regulatory subsystem that contains information on these authorities, their business rules and regulations, will assist Internet Protocol Data Insurance in meeting these requirements. Also, within the insurance industry is the practice of re-insurance, which is a mechanism for spreading risk. Re-insurance accounting and functionality will be needed to help Internet Protocol Data Insurance manage and track their reinsurance relationships.

Policy Master maintains the policy information pertinent to each customer and it is the primary insurance document. It will have the ability to handle licensees, master certificates and all the sub policies issued under each master. It also maintains the information needed to construct (or reconstruct) an actual policy contract (i.e. requires “generational” views of the policies). When the Policy Generator generates a policy, it will be automatically stored in the Policy Master.

Beneficiary maintains information on any insureds and beneficiaries related to a policy. This will be used for Provider coverage and possibly individual coverage. What we may need here is an “insured option”. This is a party or parties that have a liability if the transmission is not delivered and as such may receive compensation or legal defense if a transmission is lost. For corporations, this may have to be an option that is selected, but the information is kept with individual filters and passed along in the tracking mechanism.

Risk Assessment Factors maintains information on risk factors and underwriting and rating rules on how these factors are used to determine a policy's premium and special terms applied to a specific transmission.

Regulatory Authority maintains information on insurance regulatory authorities and the rules required by the authority.

Premium Parameters maintains the business rules and actuary tables used to underwrite policy premiums.

Policy Contract Author maintains all versions of the legal terminology used to generate policies for supported regulatory authorities. It also contains the terminology used to construct special policies, conditions, endorsements and customer terminology written for specific customers. This information will be version controlled with date/time stamp trail—so that older policies can be reconstructed at any time.

Policy Generator is used by agents to gather the information from a customer needed to create a policy. There will also be a simplified generator for web customers.

Customer Installation Package is the software components used to create the modules and tables which are downloaded to a customer's site so they can begin to insure transmissions. The Installation “Package”, its Internet Protocol Data Insurance software and ALL intellectual property remain the property of the Internet Protocol Data Insurance Policy Author.

Policy History is used to retain historical policy information. It is used to verify claims that took place in the past, against policies that are no longer current, as well as policy audits, re-insurance audits, and evidence for regulating authorities. It is also used for analysis and research.

Audit and Renewal Cycle is driven by the Policy History Module. This component monitors policy status and claims status and alerts agents when a customer policy should be audited or reviewed as well as the customer's compliance and historical claim results. This module also prepares renewal rates, terms and conditions for renewal

Policy Verification Information provides the verification criteria and components required for each policy. Some of these component are created for the Customer Installation package and are used by the customer's modules to verify insurance being issued at the customer's site. Similar sets of components are used at the Internet Protocol Data Insurance's tracking servers to verify usage and compliance with policy conditions.

Reinsurance Functionality tracks the reinsurance being applied to policies and/or cells, calculates premiums due re-insurance intermediaries reinsurers and retrocessionaires, and address all other functional requirements for re-insurance to perform properly.

The Policy Management System has two separate natures. One nature encompasses the components that reside at Internet Protocol Data Insurance (or at Internet Protocol Data Insurance customers that license the internal software). These components requirements can be dictated by Internet Protocol Data Insurance's needs and run on the servers that Internet Protocol Data Insurance controls. Due to this control, Internet Protocol Data Insurance can choose the operating systems, databases and software used by these systems. That said, the long-term objectives are to make these as hardware and database independent as possible but it may not be absolutely necessary in all cases.

The other major component of the policy system deals with the Customer Install “Package” that represents the compilation of modules which resides at the customers' sites. This set of components will be required to be as interoperable as possible because we do not want to dictate major infrastructure requirements to our insured customers. The system will operate on their hardware and software, details of which are provided in the transmission insuring mechanism section.

Another key requirement is that this system has to be flexible and table driven. Due to the nature of the business Internet Protocol Data Insurance is undertaking, it is expected that business processes will need to be refined as we grow and that government regulations will be developed to control this emerging section of the insurance industry. We must be able to meet those new developments.

In general, all components are required to be modular and object oriented. All code is to be internally generated and documented. Programming, User and Operations documentation is required. Reusability modules and standard utility functions, such as error handling and reporting, help functions, etc. are required. All errors are to be trapped and reported. Whenever possible, business rules and codes should be table driven and compared to errors trapped and reported.

When a sales agent begins work with a new prospect or an established customer, data will be required to qualify the customer and the sales activities. Existing customer information, or prospect identification information, will be available to the sales agent or can be created by the sales agent. In addition, tools will be available to the sales agent to log sales activities, define policy requirements and calculate premiums and provide customer trends. Ideally, all of this can be supported via the web-site and/or stand-alone on the sales agent's laptop (using export/import functions from the web-site). One of the key tools will be the policy generator, which provides the ability to dynamically create a customer's policy. The Policy Generator functions will be controlled by the Company.

General requirements for the sales processes may include (1) Presenting the sales agent with all pertinent customer information; (2) Allowing customer information to be submitted by the sales agent; (3) Providing the sales agent with tools to make policy creation simple and demonstrate sales demo; (4) Capturing sales information at the point of sale as well as information required to validate security data protocols of the customer's online access infrastructure and firewall protection; (5) Managing the sales approval cycle and issue Policy Generator to customers' data hardware; and (6) Perform a risk assessment at a level appropriate to the coverage requested in the policy to confirm information gathered and determine policy conditions required to initiate an insured transmission or transaction

When a sales agent meets with corporate clients, it is important to be able to present a clear image of the insurance choices and the cost. This should be done in a simple and consistent manner, but with the ability to easily make modification for the client.

To meet that requirement, Internet Protocol Data Insurance will supply the sales agent with a key tool, the demo Policy Sample Generator. The Policy Sample Generator assembles and creates the policies and endorsements that the corporation would like to purchase or amend. It also computes the range of cost of that insurance.

The submission and approval cycle is a process to obtain managerial approval on sales and policy agreements that fall outside of specific guidelines for large customers rules and exceptions or exclusions will be part of the submission and approval process.

General Requirements for the Submission and Approval Cycle are easy for the sales agent to create and submit the sales contract proposal.

Table driven workflow of approval/dispute cycle includes: Flexible criteria for creating guidelines to determine if special approval is required; Flexible criteria set up for selecting approval path; Workflow incorporates delay or detour and other timing aspects in determining path; Provide method to expedite a specific policy with conditions and exclusions included; Automatic interface with other Internet Protocol Data Insurance processes; Creation/maintenance of policy information; Creation/maintenance of customer information; Automatic update of accounting processes after approval; Automatic interface into a sales commission application;

When a sale requires negotiations, some compromises beyond normal guidelines may be required. Using the Policy Generator, the salesperson has at his/her disposal sales tools that can be applied to the insurance package being submitted for approval. If the final negotiated premium falls below an established margin, then safeguards must be put in place to assure that the sale is acceptable to the sales agent's managers, underwriters and re-insurers.

To achieve this level of control, a sales approval cycle will require managerial consent for any sales agreements outside established guidelines. The sales agent will submit the policy and sales agreement to Internet Protocol Data Insurance. If the sale is within the guidelines, the sale will be approved. If the sale is outside those guidelines, it will be routed within Internet Protocol Data Insurance, in a sales and underwriting approval cycle.

This submission and approval process will route the sales agreement to key personnel for approval. The list of personnel and the approval route will be table driven and easy to modify. The system will provide simple workflow management. Alternate routes could be taken for approval due to “away” (delay) time or lack of responses within a set deadline. A process will be available to expedite the approval cycle for a key customer.

The purpose of the Policy Management System is to define, generate and maintain policies for Internet Protocol Data Insurance Transmission Insurance. An ancillary function of this application system is to configure the components necessary for the Customer Installation Module (objects necessary for operation of the insuring function, which must reside at the customer's site).

Creating and servicing transmission insurance policies is one of the prime business functions of Internet Protocol Data Insurance. As stated above, it is the intent of this business process to be a highly automated, to make it easy for an agent to gather a customer's policy requirements and generate a policy. If the policy falls within approval guidelines, it will be automatically approved otherwise it will be sent through a management approval cycle.

Policy creation is intended to be simple and consistent. Once a policy request is submitted and approved, the Policy Management System at Internet Protocol Data Insurance will use the information supplied by the Policy Generator to automatically generate the policy and to store that information in Internet Protocol Data Insurance's customer and policy databases. A method will also be available to create and modify policy packages without using the Policy Generator for special or unique risks.

To automatically create-underwrite a policy which requires the following functionality: Determine risk and premium (underwrite based upon variables establish by agreement); Create the actual policy contract including conditions, endorsements and exclusions (accommodate variations by regulatory authority); Route policies for approval (if applicable); Track reinsure process for policies (if applicable); Create and maintain detailed policy information on each policy written (or pending) for a customer. This can be done via the Policy Generator or done manually; Data must be available on pending, current and obsolete policies with effective date information for claims processing (generational views & audit requirements); Create and maintain regulatory business rules to comply with statutory regulations; Manage policy adjustments, endorsements, conditions and exclusions; Manage policy renewals; Interface with other Internet Protocol Data Insurance systems such as; financial, sales management and data warehouse; Generate the Customer Installation Modules and the table information needed to install, configure or update a customer's insurance product; Validate insurance usage; Track insurance usage; Bill insurance premium(s) earned and compute tax and re-insurance for each insured transmission or transaction.

Within the Policy creation-maintenance function the Policy system need components listed: Policy Generator

The Policy Generator is an automated tool that helps the customer define the policy that best suits their needs and calculates the premium for that policy. There will be two versions of this tool, the Corporate Policy Generator for corporate accounts and a Basic Policy Generator for use by the general public.

The front-end purpose of the generator is to guide a prospective or existing customer through the selection of the various coverage types, endorsements and options and to calculate the resultant premium(s). It will also collect key risk assessment information. The back-end purpose of the Policy Generator is to provide definition input to the Policy Management System. Direct or indirect sales agents will use the more robust Corporate Policy Generator with large corporate customers. In the near future, the occasional customer will use the Basic Policy Generator via the Internet Protocol Data Insurance website or through “cloud-computing” access.

Internet Protocol Data Insurance will initially develop the Corporate Policy Generator because the corporate market is the target for the product introduction. The generator is basically a series of Smart Forms (SF) that collect and store customers' selections and responses to questions. These responses define their policy, endorsements and options in detail. The following section will provide a summary of this capability.

The Corporate Policy Generator allows the sales (cloud-computing interactive) agent to easily guide a corporate prospect or customer through the process of defining “transmission or transaction insurance” and the policy enrollment requirements. This function will normally be accessed via a secure agent interface through the Internet Protocol Data Insurance partner's cloud-computing interactive data center or website. The information may also be input off-line from a sales rep's laptop and uploaded to Internet Protocol Data Insurance (cloud-computing interactive data center) later on after risk assessment and policy parameters are certified by risk-rate approval.

The agent or cloud-computing interactive data center may use the Policy Generator to guide the prospect/customer also through the following process: Selection and analysis of coverage and endorsements; Specify insured value desired for each transmission; Select level of service; Specify insured transmission characteristics and requirements; Select reporting and billing options; Supply key risk assessment information dependent upon coverage selections.

The Corporate Policy Generator will interface with the Policy Management System to generate a proposed policy and quote for the Internet Protocol Data Insurance approval cycle. Policy components include a Declaration, Insuring Agreement, Inclusions vs. Exclusions, Conditions, Definitions and Endorsements, and Annual Aggregate Claims Cap or Master Policy Insurance Limit.

In addition to defining (proposed) policy and calculating premiums, the Corporate Policy Generator will populate the Customer/Policy Database with the data necessary for the Policy Management System to generate the “Customer Installation Module.” The software and all intellectual property remain the property of Internet Protocol Data Insurance. The software is provided to the customer via an Internet Protocol Data Insurance Lease and Software Maintenance Service Agreement.

Once the Master Policy and corresponding risk assessment is identified and entered (by agent), it is submitted for Internet Protocol Data Insurance risk rating and approval.

The Policy Generator is part of this system. See Policy Generator Requirements for definitions.

Policy Master maintains the customer's Master Policy information. It will have the ability to handle licensees, Master Certificates of insurance, additional insured, and all the sub-policies issuable under each master insurance declaration. It also maintains the information needed to construct (or reconstruct) the actual, dynamic (data) transmission-transaction policy.

Master Certificates are issued for a “group” policy. They are set up as an overall umbrella over a group of individual or sub policies. They have a master aggregate limit, which is used to limit the insurers overall liability. For example, the web site will operate under a master certificate. (It may even operate under more than one master certificate). All policies issued from the site will be issued under the master certificate. Note: the groups that define a master certificate must be formed for a purpose other than insurance, or for companies with multiple subsidiaries.

There are several methods of creating and maintaining this information. The information can be automatically created (or updated) from the policy agreement constructed by the sales representative using the Policy Generator. Once the policy agreement has been reached the Policy Generator can automatically update the policy master and the customer master. This information can also be automatically generated from purchase of insurance from the web-site, or as part of the Internet Protocol Data Insurance Software Maintenance Service Agreement.

The web site policies are probably policies issued under a master certificate. In addition, a GUI maintenance function will be required for corrections, additions, or unique (custom) policy creation.

Policy Master information will be used to produce the actual legal policy contract. Policy master tables will contain information on general policy information, terms, conditions and exclusions: Policy Selections; Master Certificate ID (if applicable); Customer ID; Policy ID; Location where contract was created (i.e. what regulatory authority applies); Location of Customer; Insurance Agent (cloud-computing interactive data center agent); Overall Policy Limits and Exclusions; Policy Effective Dates (Data Timestamp: TCP/IP transmission time sent and received); Policy Aggregate Limits; Limit per Transmission; Limit per Transaction; By Customer; By Policy; By Master Certificate.

Actual Policy premium may include any policy premium discounts, due to deductibles, retentions, etc.; System Calculated Premium; Risk Rating (Internet Protocol Data Insurance proprietary protocols); Insuring company (if licensed by Internet Protocol Data Insurance to third-party insurer); indicator how to handle duplicate filters within categories.

Coverage Specifics may include Coverage Types; Policy Categories; Endorsements; Policy Limits by; Coverage Type; By category; What are the category criteria; Limit (currency and/or percent in denominations: Dollars, Euros, Yen, Yuan, etc.); Delivery point; Security options; Specific Policy parameters; Specific Policy exclusions; Specific Policy conditions; Specific Policy endorsements; Specific Policy modifications to policy due to regulatory issues.

Following may be specific to a type of policy or general insuring requirements and include Beneficiaries (named insureds, additional named insureds, etc.); Policy risk factors and assumptions and conditions; Info as to customer site, and subsidiaries to produce Installation Package that may include; Types of plug-in needed or downloaded; Insurance administrators ID for support and claims processing (TPA maintained); Links to other services provided; Types of Security Modules purchased or required; Pointers to the Policy Contract Terminology Construction Tree—so policy contract can be printed and/or recreated or updated; Delivery point—server or user; An audit log of changes and who made them will be required.

Also a system control file for special information such as: Internet Protocol Data Insurance's aggregate limit; Automatic approval guidelines/rules; Current discounts and promotions.

The policy information will need a very flexible query and reporting capabilities. The system may need to accommodate an “additional insured option”. This is a party or parties that have a liability if the transmission is not delivered and as such may also have a claim or liability if a transmission is lost. For corporations, this may have to be an option that is selected, but the information may be kept with individual filters and past along in the tracking mechanism. An example would be a Law firm that makes the transmission receiver the “insured” as the receiver would be the one to incur the loss if the transmission fails.

This component maintains information on risk factors and rules related to those factors that are used to determine a customer's risk rating. This would require a table maintenance function to create and maintain a set of risk factors and their affect on a policy premium. These factors may include items such as high-risk locations (either as sender or receiver), transmission size/volume, method of transport control protocol (TCP), etc.

When documenting Policy assumptions the Internet Protocol Data Insurance system prepares to underwrite a policy, information will be gathered (as much as possible) about online data risk factors. This information will be tracked, monitored and stored with the Internet Protocol Data Insurance Policy History as Internet Protocol Data risk metrics and risk assumptions about current and previous policies in transmission or transaction. This information will be collected (warehouse archived) and used to calculate future risk rates that will be used in determining future Premiums and Limits. (See Policy History)

This information can also be used at policy renewal time to compare transmission patterns against initial risk assessment assumptions. This may to be used to determine the following: Have patterns changed over time; Have patterns never fit initial responses (intent to deceive); What changes should be made in policy at renewal time; Is a premium increase or a credit warranted.

During claims processing this information may be assessed to determine if there is a reason to investigate a claim. Note: there is a clause we can use called “increase in hazard” which is the ability to deny after a claim happens—if the claim is for something we thought we weren't insuring. This is one of the reasons documenting Policy Assumptions is very important.

Periodical, risk factors will be compared against actual traffic history to determine if the factors are still valid and modified accordingly. Note: version control will be applied here as well.

Because insurance is a highly regulated industry and the regulations can vary depending on “where” the policy agreement is completed, the policy rules can vary by state or country. This component maintains information on insurance regulatory authorities and the insurance and policy rules related to that authority. Its function is to insure that Internet Protocol Data Insurance meets all regulatory requirements. It is assumed at this point that we fall within the property and casualty and marine insurance business and regulations depending on location on admitted and non-admitted forms, but shall meet requirements promulgated in the domicile when the Master Policy is issued.

When a policy is sold, the location of that sale will be required so that the appropriate rules are applied. We will also need the location of the policyholder because rules and or taxes may be required from that location as well, if it differs from the contract location.

In conjunction with location information, we may need a hierarchy (tiered) table of regulations that points to all the regulations and rules under which a location functions. For example, in the US insurance is regulated by state but there may also be county or city regulations on insurance as well. In EU, Asia etc., we might encounter other situations with layered regulatory rules. These rules and regulations may affect the actual policy being offered and the policy terminology. Note: since these regulatory requirements are beyond our control, the hierarchical structure will accommodate the possible changes in the future (e.g. U.S. may institute federal regulations at some time).

In addition, we will need to keep information on the reporting requirements for each regulatory authority and have processes to produce the appropriate reports. This function will use graphical user interface (GUI) and/or cloud-computing functionality to maintain the various tables and business rules. It will be flexible, cross platform adaptable construct, Extensible Mark-up Language (XML) for the rules and regulatory requirements to be interoperable, and also they can be data exchangeable and table driven.

It will also require flexible reporting and query functionality. This component maintains the business rules and actuary tables used to underwrite policies. When a policy is created, or amended, a process will have to be performed that determines a premium for the policy. It will use the policy information for items such: Risk Rating; Assumed Volumes; Assumed Sizes (data payload size: Kilobytes, Megabytes, Terabytes, etc.); Aggregate Limits; Limit per Transmission; Limit per Transaction; Policy Limits; Policy Coverage; Policy Conditions; Policy Endorsements; Security Modules (required encryption, compression, firewalls, etc.).

The calculated premium may be overridden and appropriate rate debits or credits applied with management approval. This function will require a GUI for table maintenance and reports and query functionality. This component maintains the legal terminology used to generate policies. It also contains the terminology used to construct “Manuscript” (i.e. custom) policies. This information must be maintained continually with version and date control—so that older policies can be reconstructed at any time.

Policy sections include: Declarations; Insurance Agreement; Exclusions; Conditions—(what Customer must do in a case of a loss/conditions necessary for insurance to apply); Definitions; Endorsements—(Customer wants special or exclusive modifiers to policy).

There will be standard legal terminology for these sections with places to input variables. The variables come from the policy master data. Variable terminology may also be imposed from the regulatory authorities.

This section must also allow for specific terminology to be entered for a particular customer, which overrides the standard terminology. A methodology will be in place to address special policy terms and language and reconstruct or save contracts.

This function will require a cloud-computing interface for maintenance of the contract terminology, both general and specific. It will also require maintenance of business rules needed to construct the policy.

Re-insurance is an insurance mechanism used to manage risk. There are two types of reinsurance agreements, proportional (treaty) and excess of loss. Proportional prorates all premiums, losses and expenses between the insurer and the re-insurer on a pre-arranged basis. Excess of loss requires the primary insurer to keep all loss up to a predetermined retention and the reinsurer to reimburse the company for losses above the retention.

There are two types of reinsurance contracts. Treaty contracts automatically cover risks that fall within their terms unless specifically excluded. Facultative contracts cover underlying individual policies and are written on an individual basis (i.e. covers specific risk with separate terms and conditions).

Reinsurance relationships range from simple to complex. An insurer may enter into a single re-insurance treaty or several agreements to reach the correct level of coverage. This is called layering and re-insurers will respond to claims in a predetermined sequence.

A Captive is an insurance company subsidiary, usually formed to insure or reinsure the risks of its parent and affiliates. In some cases, Captives are also used to insure risks that are not related to their parent organization. Captives can be used to provide coverage either directly or as reinsurance of a fronting insurer.

Most insurers lay off a majority of their risk to re-insurance. The fees paid for reinsurance are a direct proportion of the premium. For example, if company A re-insures 90% of the risk incurred by company B, then company B pays Company A 90% of the premiums.

Internet Protocol Data Insurance will use reinsurance in a number of ways and have numerous types of relations with re-insurers. It may purchase both re-insurance for Master Certificates or groups of insurance. It may also enter into agreements with re-insurers to cover individual policies.

Internet Protocol Data Insurance will own a Cell (or multiple cells) of a Captive. The Cell is covered by re-insurance for excess loss. The Cell is fully funded for the aggregate risk it assumes. For example, if a Cell is responsible for a specific “master certificate” then the Cell will be fully funded for the aggregate limit for that “master policy”.

Cells are funded in three (3) ways: Paid in capital from the owner (premium income, earnings on insurance operations); Irrevocable Letter of Credit (LOC) and Reinsurance (Excessive Loss Re-insurance) to reduce capital requirements.

Example: the “by the drink customers” purchase a policy. This policy may be under a “master certificate”. The policy states their limit for the transmission. It also states their aggregate limit for the year. It also states Internet Protocol Data Insurance's aggregate limit for the master policy. That master limit is what is covered under that cell. If the Cell covers multiple master certificates, it would have to be funded for the total of all the certificates.

Internet Protocol Data Insurance may purchase a Cell for a large corporate customer and create a tailored master policy (or certificate) for these customers. This isolates risk. It segregates large corporations' liability from each other.

A Captive Manager handles the re-insurance for a Cell. They will require records on reserves; We report premiums to the Captive Manager; He reports to the re-insurers; A re-insurance report, listing of customers, insured, and premiums is called a Bordereaux.

The System will need to track the relationships with re-insurers and Captives. It will also identify Cells, policies and conditions covered by the re-insurer(s). More than one re-insurer may take a piece of a policy.

It should also keep track of the position of policy usage against the reinsurance. For example, if a re-insurer covers a policy for every transaction over $1000 in value, these items need to be tracked, so the re-insurer can be notified if the limits are met.

The re-insurance business function will manage the following areas: Master Re-insurance Table of our re-insurers and our relationships with them: Type of agreement; contractual form and content; What is being re-insuring; objects of insurance, terms and conditions of coverage; How premiums are remitted to participating reinsurers; reimbursement for carriers fronting fees; claim adjudication and reimbursement for claims; Our contractual status/relationship with each participating re-insurer; and retrocessionaire's; Detail on claims incurred for payment by the re-insurer.

Information on our captive Cells: how Cell is funded and its operational financial condition; Cell's Purpose (what the Cell covers); Cell Captive Manager; Cell Re-insurers; Cell Status. (maintaining financial viability of the captive cells).

This business process features special accounting interfaces with the following: Update Accounts Payable with the information necessary to pay the re-insurers premium; Update Accounts Receivable with all earned premium, earned fee and other data critical to the accounts receivable function; Update Accounts Receivable when a re-insurer is expected to satisfy a claim or update the status of pending claims; Accounts Payable if the re-insurer wants a reduction or increase in premium to satisfy a claim. In some cases, Internet Protocol Data Insurance may be the re-insurer. In that capacity there are other accounting implications to how that money is regarded. (business expense).

Once a policy is created and approved, the policy contract will be fulfilled. The customer must be provided the components required to insure transmissions and to begin using their transmission insurance. Internet Protocol Data Insurance will automatically provide these customer components in the instillation package.

In addition, Internet Protocol Data Insurance or one of its affiliated Systems Integrators may provide professional services to the customer to do the following: Help install and configure the Internet Protocol Data Insurance Transmission Components; Provide training and support for the Internet Protocol Data Insurance Components; Provide security and risk assessment services; The insuring and rating software is proprietary and will remain the property of Internet Protocol Data Insurance under the Internet Protocol Data Insurance Lease and Maintenance Service Agreement.

Internet Protocol Data Insurance will begin the process of collecting transmission events and totals to insure the customer's contract obligations are fulfilled. Transmission events are verified as they occur both at the customer's site and at Internet Protocol Data Insurance's logging service. Errors are logged at both sites and notifications are sent to the appropriate personnel. (See Internet Protocol Data Insurance Tracking System)

Policy history is kept on line for as long as a claim can be made against a policy. Then it is archived (warehouse) for legal and data analysis purposes.

Policy renewal cycles are also part of the policy lifetime. The system will notify the appropriate agent (cloud-computing agent) whenever a policy is up for renewal or audit, or if activity against a policy indicates the customer policy requires adjustment.

The policy lifetime functionality requires the components listed below. This Internet Protocol Data Insurance Customer Installation Package is used to assemble the modules and tables to be download to a customer's site so they can begin to insure transmissions. See the Internet Protocol Data Insurance Tracking System, Transmission Insuring Mechanism for a functional definition of this process and what is generated.

This system will track the downloads made by a customer and be able to post upgrades and patches to modules as released to clients. Downloads will be smart enough not to overlay a customer's custom information—such as their filters.

Security will be required for anyone to access and download Internet Protocol Data Insurance Customer Installation package updated Components or modules. The Policy History Component is used to retain historical policy information and has two critical functions.

The first set of Policy History is for recent policy changes and it is stored online. It is used to verify incurred claims which took place in the past, against policies that are no longer current. (There is probably a time limit on when claims can be made.) It may also be used for policy verification of an action when a tracking event or a claim reaches Internet Protocol Data Insurance after a policy update.

The second set of historical policy information is to warehouse or archive historical policy information for historical policy reconstructions. This is done when the policy can no longer be used by a customer, no claims are pending on the policy and no new claims can be processed against that policy. This is being stored for historical and regulatory reasons. It is also used for analysis and research rate making and refinement of policy terms and conditions. It is stored from the first set of historical policy information only—never from actual “in force” Policy Masters.

This component monitors Policy status and claims status and alerts agents when a customer policy requires audit or review. It will be triggered by several different component Interfaces.

First Audit Cycle determinate will be time. Internet Protocol Data Insurance will have an audit or renewal process that automatically notifies designated representatives to visit major clients to discuss renewal terms, conditions and rates, or conduct an audit based on table driven factors i.e.: failure; rates, security configurations and so forth; Results of audits will be stored and analyzed against policy assumptions; Audit results can affect premiums and cause an increase in premiums or a premium credit. This information will be automatically interfaced to the appropriate financial systems, including account receivable and claims

Second Audit Cycle will be usage—if statistics or traffic patterns indicate there is or could be a policy problem this will be proactively acted upon and Internet Protocol Data Insurance Policy's modified to conform to changing client conditions.

This component provides the verification criteria required for each policy. These Components are used by the customer's modules to verify insurance being applied at their site. It is also used at the Internet Protocol Data Insurance's tracking site to verify usage. It will also be used by the claims process, as one of the steps needed to authenticate and validate a claim.

This functionality will retain running totals against Policy usage as it relates to policy assumptions. For example a customer buys insurance to cover 20 documents at $300 Limit of insurance each. He insures 21 data transmissions or he increases the Limit amount ($) to $1000 on one individual data insured transmission (document) which manually modified the cover he agreed to originally insure—then Internet Protocol Data Insurance shall provide a tracking method that can adjust to what has been originally insured in this case. There are multiple verifications, interactions, and Internet Protocol Data Insurance modifications or variations that will be possible.

The Policy Management process shall interface with the following systems: Inputs to other systems (interoperability); Provides information to Accounts Receivable (A/R) for policy premiums and policy over usage; Provides information to Accounts Receivable (A/R) for re-insurance claims payments; Provides information to create/update customer in A/R from Policy generator; Supplies policy parameters used by Internet Protocol Data Insurance's tracking for verification; Creates Installation package for customer; Supplies sales system data and creates sales reports for management; Feeds sales approval cycle; Feeds Accounts Payable (A/P) for customer adjudicated claims. (vendor required); Feeds a sales system or A/P for agents fee (maybe); Provides information to A/P for Reinsurance premiums; Receives information from other system; collects information from the tracking system on usage; collects agent identification from the sales system; Accepts responses from sales approval cycle; track downloads by customer of upgrades and product enhancements; provides A/R customer identification and status on existing customer; verifies credit worthiness of new customer A/R or Policy Management (P/M); Receives claims information and integrates with financial and underwriting reports.

Regulatory authority is determined by when contract is completed based upon client domicile at time of policy issuance. If a regulatory authority requires payments of taxes, licenses or other policy expenses—the link to A/P will come from Internet Protocol Data Insurance tables.

We shall identify policy specifics—for example—a risk factor is a location. One category of messages over a specific limit ($) may be transmissions to a country identified as unfriendly, which is a risky location—this shall dramatically affect the Premium. Internet Protocol Data Insurance requires a “Policy Generator”, an automated tool to help the customer define the Policy that best suits their needs and calculate the premium for that Policy. There will be two versions of Internet Protocol Data Insurance's Policy Generator: The Corporate Policy Generator for corporate accounts, and; Less robust Basic Policy Generator for use by the general public. (via Internet Protocol Policy web site).

The purpose of the Policy Generator function is to guide a prospective or existing customer through the selection of various policy options that are available and calculating the resultant premium(s). The more robust Corporate Policy Generator is intended for use by the Agent or cloud-computing Intelligent Agent (IA). The Basic Policy Generator is designed for use via the Internet Protocol Data Insurance web site by the individual person.

Internet Protocol Data Insurance will initially develop the Corporate Policy Generator since the corporate market is targeted for the product introduction. The Generator is basically a series of Intelligent Agents (IA) Smart Forms (SF) that collect and store the customers' selections, essentially defining their Policy in detail. The following section will provide a high-level functional view of this capability.

Level 1a. The initial choice is to select a Policy coverage, which defines which transmissions will be covered, and fixed (Limit) amount of the coverage for each transmission.

The three policy choices are: Universal Policy—all Internet Protocol Data Insurance transmissions are covered; Defined Policy—specific (defined) transmissions (e.g. message types) are (covered) insurable; and Select Policy—transmissions are selected on a case-by-case basis by the customer for coverage.

On initial pass, go to LEVEL 2c. Subsequent passes (if required) will start at Level 1b.

Level 1b. The Smart Form presents choices for available Endorsements to the primary Policy selected at Level 1a. The Smart Form will automatically configure itself to the appropriate endorsement options for the primary type of policy.

The three endorsement configurations are: universal Policy—Endorsement Option; Select Endorsement with Variable Coverage (for varying the coverage value for selected transmissions); Defined Policy—Endorsement Options; Defined Endorsement (for defined transmissions in addition to those covered in the primary policy or other endorsements); Select Endorsement (for customer case by case selection of insured transmissions in addition to those covered by the primary policy or other endorsements, and/or to vary the coverage value for selected transmissions); Select Policy—Endorsement Options (no optional endorsements defined for Select Policies at this time).

Level 1c. Always go to Level 1c. For the policy or endorsement selected in this pass, provide information about desired dollar amount of the insurance coverage for these transmissions.

For these transmissions, specify the default amount of insurance coverage desired for each transmission in the Internet Protocol origination-location, currency (e.g. US Dollars, Euros, and Yen).

The following items only appear on this form if a Select Policy or Endorsement has been chosen for this pass. For this Select Policy or Endorsement, the (premium) amount of insurance coverage can be changed at time the selection is made. (Yes/No only).

If insurance coverage (premium) amounts can vary from the default, a specified minimum and maximum amounts shall be allowed for each transmission in (e.g. US Dollars, Euros, Yen) a minimum amount and a maximum amount.

Level 2. Always go to Level 2. The next choice is to select a level of service, which defines what services Internet Protocol Data Insurance will provide for the transmissions selected at Level 1a or 1b.

The choices are as follows: Transmission insurance only; Transmission insurance plus one or more of the following security options: Public key encryption (PKI, 128 bit, 256 bit, etc.); Advance Encryption System (AES); Non-repudiation delivery; Message integrity monitoring/reporting (Security: special data tracking); Recipient password authentication (dual authentication); Routing control with traffic flow confidentiality; and Point-to-point VPN security via Internet Protocol Data Insurance (certified covered server).

Go to Level 3a if a Select Policy or Endorsement was selected on this pass. For all other Policies and Endorsements, go to Level 3b. If the Select Policy is chosen at Level 1, this Smart Form is invoked to indicate message filter requirements; otherwise control passes to Level 3b. Select Policies or Endorsements require a message filter to identify which transmissions are covered by the policy/endorsement. At this level, the customer must specify whether they need a “Standard Message Filter” or a “Custom Message Filter”. Standard Message Filters are prepackaged by Internet Protocol Data Insurance, and Custom Message Filters can be developed for those Defined Policies that do not fit into the Policy Limits, inclusions, exclusions or modification schemes provided by the standard filters such as standard Message Filter; Messages from specific server(s); Messages from specific sender(s); Messages to specific receiver(s); Messages between specific sender/receiver pair(s). Custom Message Filters may be developed for other identification schemes.

Level 3b. Always go to Level 3b. At this level we require some basic information about the “class” of the covered messages and their delivery mechanisms, as well as message volumes and sizes. This information is used to identify which versions of a filter (or plug-in for the Select Policy/Endorsement) is required for this customer. The following information is required: Message Class may include SMTP—Email Customer; FTP—FTP Customer; EDI—EDI Translator/ERP Package; WAP—Wireless/Cell phone user (WEP2). Monthly Transmission Volume may be rated by Maximum, Average or combination thereof. Message Size (in kilobytes, megabytes, etc) may be rated by Maximum, Average or combination thereof.

At this point the policy/endorsement defined in this pass is complete. If additional endorsements are desired, go to Level 1b, else go to Level 4 to complete this process.

Level 4. At this level the Generator collects information about which reporting options (if any) the customer desires. (Summary account reconciliation is provided with all corporate accounts on a monthly basis.) Selected reports are delivered to the customer's Transmission Insurance Administrator electronically. The reporting options are:

Message transmission failure/message integrity breach reporting (reporting of integrity breaches dependant on selecting that level of service) such as insured transmission summaries (Daily/Weekly/Monthly); Detailed traffic reports (Daily/Weekly/Monthly); and Monthly detailed account reconciliation: Always go to Level 5.

Level 5. If collected when the prospective customer profile was created, then billing options will be displayed for acceptance/modification; if not they will be selected at this level.

The available billing options are: Annual billing (with monthly reconciliation); Semi-annual billing (with monthly reconciliation); Quarterly billing (with monthly reconciliation); Monthly billing (with weekly reconciliation); Weekly billing (with daily reconciliation); Daily billing; Hourly billing; Per Minute billing; Per Second billing; Per Hundredth-Second billing; Per Thousandth-Second billing and Per Millionth-Second billing.

It is contemplated that features disclosed in this application, as well as those described in the above applications incorporated by reference, can be mixed and matched to suit particular circumstances. Various other modifications and changes will be apparent to those of ordinary skill.

1. An internet protocol data insurance policy management system comprising:
creating an insurance policy portfolio;
determining a risk associated with an electronic transmission based upon the insurance policy portfolio;
generating an insurance policy based upon the insurance policy portfolio upon receipt of a electronic transmission identifier from a first computer client, wherein the receipt of the electronic transmission identifier from the first computer is indicative of an electronic transmission being transmitted from the first computer client to a second computer client that is distinct from the first computer client; and
terminating the insurance policy when the electronic transmission identifier is received from the second computer client, wherein the receipt of the electronic transmission identifier from the second computer client is indicative of the electronic transmission being received by the second computer client.

2. The internet protocol data insurance policy management system of claim 1, and further comprising generating customer installation modules to create insurance policies using the internet protocol data insurance policy management system.

3. The internet protocol data insurance policy management system of claim 1, and further comprising creating and maintaining regulatory business rules for insurance policies created by the internet protocol data insurance policy management system.

4. The internet protocol data insurance policy management system of claim 1, and further comprising validating insurance policies created by the internet protocol data insurance policy management system.

5. The internet protocol data insurance policy management system of claim 1, and further comprising tracking insurance policies created by the internet protocol data insurance policy management system.

6. The internet protocol data insurance policy management system of claim 1, and further comprising logging insurance policies created by the internet protocol data insurance policy management system.
